(19) United States
(12) Patent Application Publication
(10) Pub. No.: US 2026/0148496 A1
(43) Pub. Date: May 28, 2026

(54) MACHINE LEARNING FOR THREE-DIMENSIONAL VECTOR MAP EXTRACTION

(71) Applicant: ECOPIA TECH CORPORATION, Toronto (CA)

(72) Inventors: Kai Jia, Toronto (CA); Yuanming Shu, Toronto (CA)

(73) Assignee: ECOPIA TECH CORPORATION, Toronto (CA)

(21) Appl. No.: 19/179,124

(22) Filed: Apr. 15, 2025

Related U.S. Application Data
(60) Provisional application No. 63/714,450, filed on Oct. 31, 2024.
(60) Provisional application No. 63/788,409, filed on Apr. 14, 2025.

(51) Int. Cl. G06T 17/20; G06N 20/00; G06T 9/00; G06T 17/10

(52) U.S. Cl. CPC G06T 17/20; G06N 20/00; G06T 9/001; G06T 17/10

(57) ABSTRACT

Methods and systems for generating three-dimensional vector maps representing three-dimensional features are provided. An example method involves accessing multiview imagery that depicts a three-dimensional feature, applying a machine learning model to the multiview imagery to generate a representation of the three-dimensional feature, and outputting the representation.

### BACKGROUND

Geospatial information is commonly represented as raster data or as vector data. Raster data can be used to represent an area of the world as a regular grid of cells, with one or more attributes associated with each cell. A common example of geospatial information represented as raster data is a geospatial image, which is essentially a grid of pixels (e.g., attributed in 3-band or 4-band). In contrast, vector data can be used to represent geospatial information extracted from imagery as a set of attributed geometric entities (e.g., polygons, lines, points). Vector data may be preferred over raster data in applications where scalability, compactness, and ease of data manipulation are desired.

Geospatial information can be manually extracted from imagery as vector data through a software platform that allows individuals to manually annotate images through a user interface. A common use case is the annotation of geospatial imagery to produce two-dimensional vector maps representing landcover features, such as roads, grasslands, or two-dimensional building footprints. These tasks can be extremely time-consuming, costly, and impractical at scale. Therefore, a previous disclosure, U.S. patent application Ser. No. 17/731,769 (the '769 Application), describes how a machine learning model can be used extract vector maps representing geospatial information from imagery in an automated way. The '769 Application also describes how a machine learning model can be trained to follow the patterns of how a human annotator would perform such feature extraction tasks.

In the case of three-dimensional features, these features can also be extracted from imagery manually, provided that the user is given a set of multiview imagery that depicts an object or structure from multiple perspectives and an appropriate suite of software tools that allows the user to annotate and/or manipulate a three-dimensional model in three-dimensional space. These software tools typically rely on well-known photogrammetric techniques to generate the resulting three-dimensional model. Compared to the two-dimensional case, manual three-dimensional geospatial feature extraction can be even more time-consuming, costly, and impractical at scale.

### BRIEF DESCRIPTION OF THE DRAWINGS

FIG. 1 is a schematic diagram of an example system for generating three-dimensional vector maps that represent three-dimensional landcover features extracted from multiview imagery.

FIG. 2 is a flowchart of an example method for generating representations of three-dimensional features extracted from multiview imagery.

FIG. 3 is a schematic diagram of an example machine learning model for generating representations of three-dimensional features extracted from multiview imagery.

FIG. 4 is a schematic diagram of an example system for generating geometric models of three-dimensional features extracted from multiview imagery.

FIG. 5 is an illustration of an example geometric modeling sequence that prescribes how a geometric model of a building with a pitched roof structure is to be generated.

FIG. 6 is an illustration of an example geometric model of a building with a pitched roof structure.

FIG. 7 is another illustration of an example geometric model of a more

FIG. 8 is a schematic diagram of an example geometric interpreter for resolving a probabilistic representation of a geometric model of a three-dimensional structure.

FIG. 9 is a flowchart of an example method for preparing training data to train a machine learning model to generate representations of geometric modeling sequences that prescribe how geometric models of three-dimensional features are to be generated.

### DETAILED DESCRIPTION

As described above, three-dimensional features can be extracted from multiview imagery in the form of three-dimensional vector maps through software platforms that allow individuals to manually annotate multiview imagery through a user interface. However, manual image annotation can be a laborious task, especially at large scales and at high accuracy, and especially in the case of three-dimensional feature extraction.

A previous disclosure, U.S. patent application Ser. No. 17/731,769 (the '769 Application, the entirety of which is incorporated herein by reference), describes how machine learning models can be trained to produce sequences of annotation operations that follow the patterns of how human annotators would perform feature extraction on single images. The present disclosure extends the teachings of the '769 Application for the use case of extracting three-dimensional features from multiview imagery.

The techniques described herein can be applied to extract various sorts of three-dimensional structures or objects from multiview imagery. For example, the techniques described herein could be applied to the case of extracting the three-dimensional structure of a building's exterior walls and roof based on imagery captured from one or more overhead and/or oblique perspectives (e.g., drone, aerial, and/or satellite imagery). The same techniques may be applicable to feature extraction of other outdoor infrastructure such as roads and bridges. Yet another example use case, which is illustrated in certain places in the present disclosure, is for the reconstruction of the three-dimensional geometry of a pitched roof structure (e.g., a roof structure of a typical residential home). However, it is emphasized that any focus of this disclosure on the aforementioned use case is not limiting, and that the techniques described herein could be applied to other use cases.

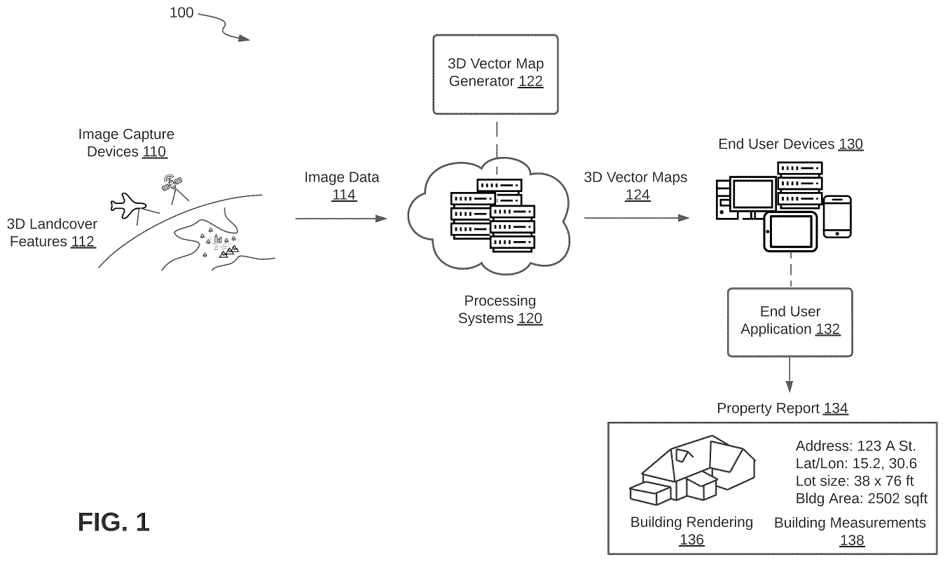

FIG. 1 is a schematic diagram of an example system 100 for generating three-dimensional vector maps that represent three-dimensional landcover features extracted from multiview imagery. The system 100 includes one or more image capture devices 110 to capture image data 114 covering an area of interest that includes one or more three-dimensional landcover features 112. For example, an image capture device 110 may include any suitable camera system capable of capturing geospatial imagery (e.g., aircraft, satellite) or other overhead imagery (e.g., drone, balloon). As another example, an image capture device 110 may include any suitable camera system capable of capturing ground-level imagery (e.g., street-view vehicle). An image capture device 110 may also include any suitable handheld device similarly capable of capturing images (e.g., smartphone).

The three-dimensional landcover features 112 captured in the image data 114 may include natural landcover features, such as forests, grass, bare land, shrubs, trees, water, and the like, or manmade land use features such as buildings, roofs, roads, bridges, railways, driveways, crosswalks, sidewalks, parking lots, pavement, and the like. A common use case for the system 100, which is illustrated here, is to extract the three-dimensional structure of a building, including its roof and exterior walls, and in particular the geometry of a pitched roof structure (e.g., a residential home).

The image data 114 may include the raw image data (e.g., 3-band or 4-band imagery) in any suitable format that is made available by the image capture devices 110. The image data 114 may further include metadata associated with such imagery, including camera parameters (e.g., focal length, lens distortion, camera pose), geospatial projection information (e.g., latitude and longitude position), and other data. For three-dimensional feature extraction, the image data 114 should contain such raw image data and metadata for a collection of multiview imagery of the feature being extracted (i.e., a plurality of images of the same three-dimensional landcover feature 112 captured from different perspectives or points of view).

The system 100 further includes one or more processing systems 120 to process the image data 114. In particular, the processing systems 120 are configured to process the image data 114 to generate three-dimensional vector maps 124 as described herein. The processing systems 120 may include one or more computing devices, containing computer processors (e.g., CPUs and/or GPUs) such as servers in a local or cloud-computing environment. The processing systems 120 may include one or more communication interfaces to receive/obtain/access the image data 114 and to output/transmit the resulting three-dimensional vector maps 124 through one or more computing networks and/or telecommunications networks such as the internet. The processing systems 120 may include memory to store the resulting three-dimensional vector maps 124 and to store executable programming instructions that embody the functionality described herein.

In particular, the processing systems 120 make use of a three-dimensional vector map generator 122 to process the image data 114 into three-dimensional vector maps 124. The three-dimensional vector map generator 122 may comprise a combination of software programs, pre-trained machine learning models, machine learning training tools, data quality control tools, and other ancillary software used to perform the functionality described herein that is involved in processing the image data 114 into three-dimensional vector maps 124. Thus, the processing systems 120 may be configured in any suitable way to store, host, access, run, execute, or otherwise utilize any of the aforementioned software, data, or other systems to generate the three-dimensional vector maps 124 as described herein.

The three-dimensional vector maps 124 contain vector data comprising sets of points, lines, and/or polygons, and may also contain the associated geometric constraints among those geometric elements, that represent the structure (i.e., geometry) of one or more three-dimensional landcover features 112 that are to be extracted from the image data 114. These three-dimensional vector maps 124 can be stored and converted into any suitable format (e.g., .shp, .cad or other file type) to be imported into any suitable software application such as a computer-aided design (CAD) system or geographic information system (GIS) for viewing and/or further manipulation. The three-dimensional vector maps 124 may be attributed with additional information such as scale or geospatial projection information. For example, the three-dimensional vector maps 124 that correspond to a building that was extracted may be attributed with location information (e.g., GPS coordinates), scale information, address data, or other pertinent information that may be available either from the image data 114 (i.e., information contained in, or derived from, the camera parameters) or other data sources.

After generation, the three-dimensional vector maps 124 may be transmitted to one or more end user devices 130, which may be used to store, view, manipulate, and/or otherwise use such three-dimensional vector maps 124 (either directly as incorporate into a particular filetype such as .CAD or .OBJ). For this purpose, the end user devices 130 may store, host, access, run, or execute one or more software programs that process such three-dimensional vector maps 124 (e.g., a GIS viewer), indicated here as an end user application 132. The end user devices 130 may communicate with the processing systems 120 to access the three-dimensional vector maps 124 through any suitable means, such as through an application programming interface (API), access through a website, or similar.

Users of the end user devices 130 may use the three-dimensional vector maps 124 for any such purposes as for city planning, land use planning, architectural and engineering work, property insurance risk assessments, environmental assessments, automated vehicle navigation, or for use in virtual reality or augmented reality systems, for the generation of a digital twin of a city, and the like. As one particular example, the end user application 132 may be configured to process a data file comprising the three-dimensional vector maps 124 to generate a property report 134, which may contain a three-dimensional building rendering 136 and building measurements 138 generated based on the three-dimensional vector maps 124. For example, the building measurements 138 could include an estimate of the square footage of the building footprint of the building, a square footage of the roof structure of the building, a height of the building (at the base of the pitched roof structure), or other measurements. Such details about the structure and measurements of the roof of the building may be useful in use cases such as insurance claims adjustment or underwriting activities.

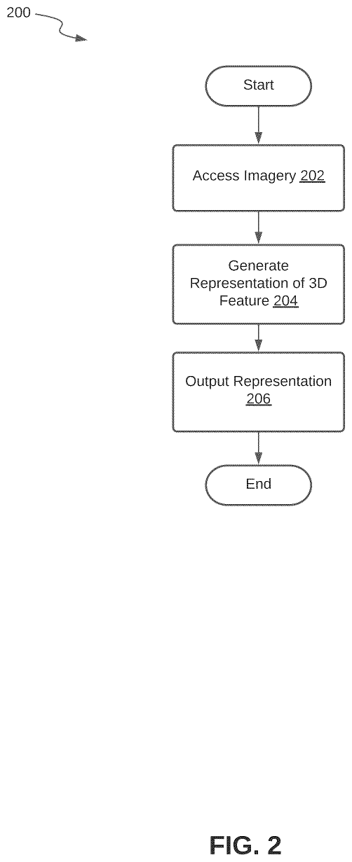

FIG. 2 is a flowchart of an example method 200 for generating representations of three-dimensional features extracted from multiview imagery. The method 200 may be understood to represent one way in which certain aspects of the system 100 of FIG. 1 may work, and thus, for illustrative purposes, certain the method 200 may be described with reference to certain aspects of the system 100 of FIG. 1. However, it is to be understood that the method 200 may be applied by other systems and/or devices and may be applied to extract representations of other sorts of three-dimensional features.

At operation 202, the processing systems 120 accesses multiview imagery that depicts a three-dimensional landcover feature 112, such as a building. As described above, such imagery may include aerial imagery, satellite imagery, (i.e., geospatial imagery), or another form of imagery depicting the three-dimensional feature 112 from multiple points of view, such as street-view imagery or smartphone imagery collected by one or more users. The multiview imagery comprises image data 114 which includes image pixels and the associated camera parameters for each image.

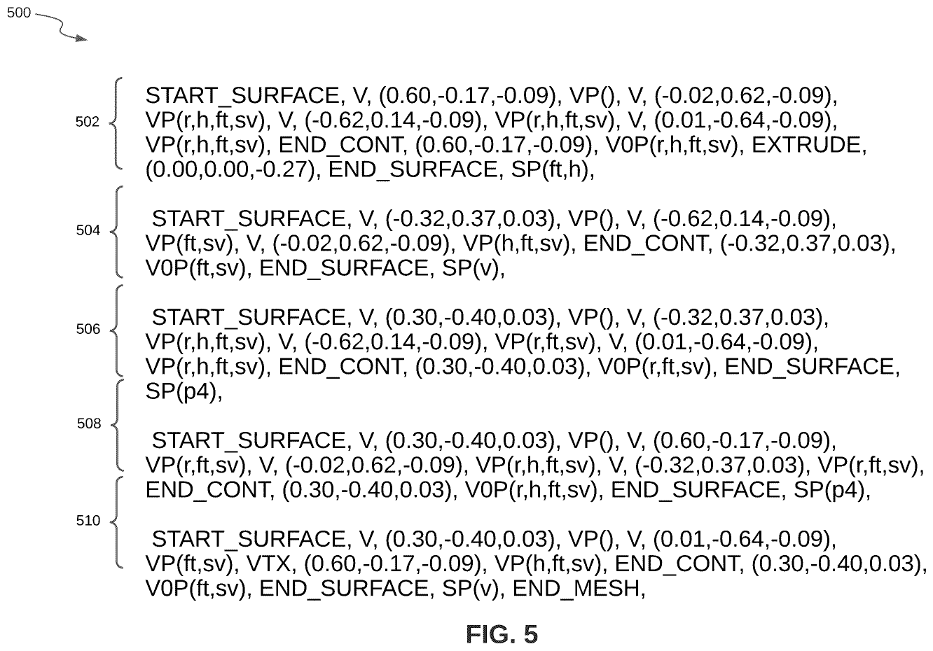

At operation 204, the three-dimensional vector map generator 122 applies a machine learning model to the multiview imagery to generate a representation of the three-dimensional landcover feature 112. This representation should be understood to refer to the tokenized output directly produced by the machine learning model. In some cases, this output representation may directly represent a set of three-dimensional coordinates that form the geometric model. In other cases, as described further below (e.g., see FIG. 5), this output representation may represent a geometric modeling sequence that prescribes how the geometric model of the three-dimensional feature is to be generated.

At operation 206, a machine learning model of the three-dimensional vector map generator 122 outputs the representation of the three-dimensional landcover feature 112.

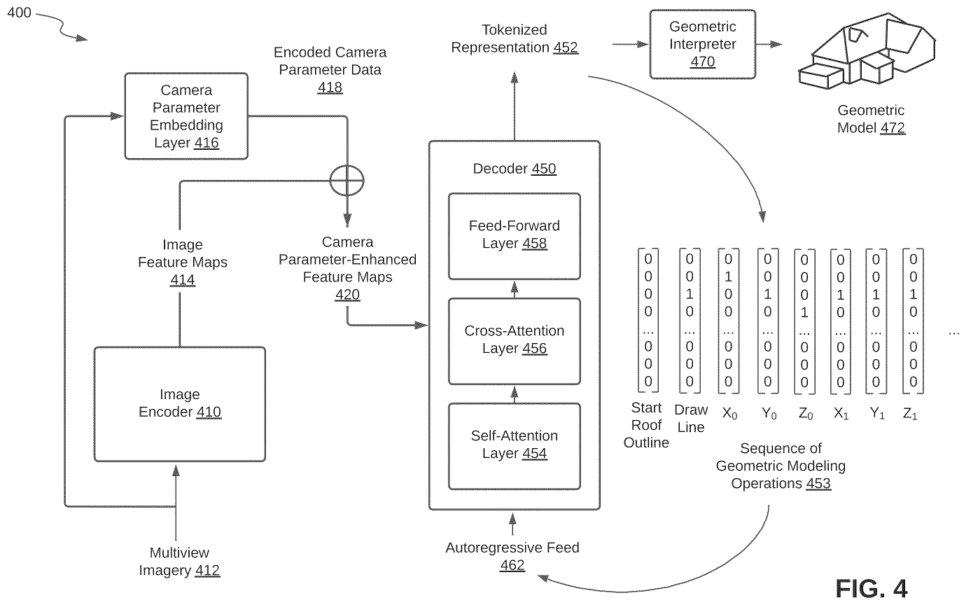

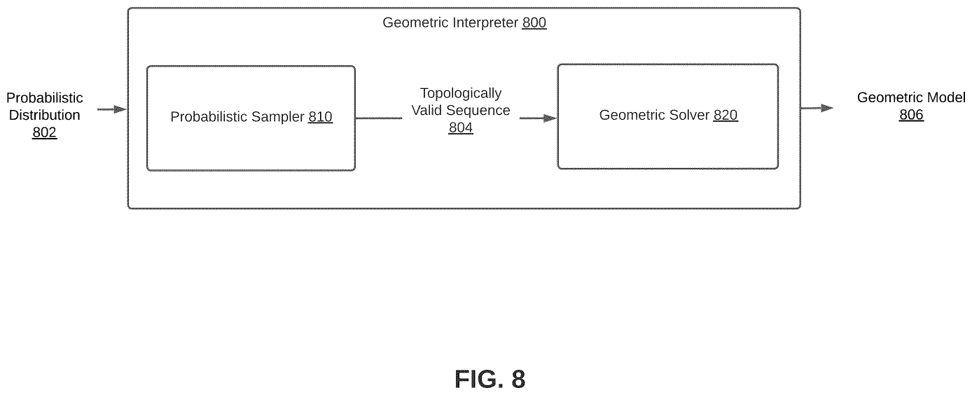

The three-dimensional vector map generator 122 may then generate the three-dimensional vector map 124 based on the output representation. This process may involve different steps depending on the nature of the output representation. Thus, the process may involve interpreting the output representation as three-dimensional coordinate information and/or as elements of geometric modeling sequence, as described in further detail below, with respect to FIG. 4 and FIG. 5, and FIG. 8.

In some cases, the three-dimensional vector map generator 122 may then attribute the three-dimensional vector maps 124 with location information (e.g., latitude and longitude), scale information, or other information that may be interpreted from the source data, or extrinsic information such as address data (e.g., where the three-dimensional feature being extracted is a building with an address), obtained from external sources.

In some cases, the processing systems 120 may then format the three-dimensional vector map 124 into an end user data file for import into the end user application 132 (e.g., CAD, .OBJ).

The steps of the method 200 may be organized into one or more functional processes (which may not necessarily be executed in the order shown) and embodied on a non-transitory machine-readable storage medium in programming instructions executable by one or more processors in any suitable configuration, including the computing devices of the systems described here, such as the processing systems 120.

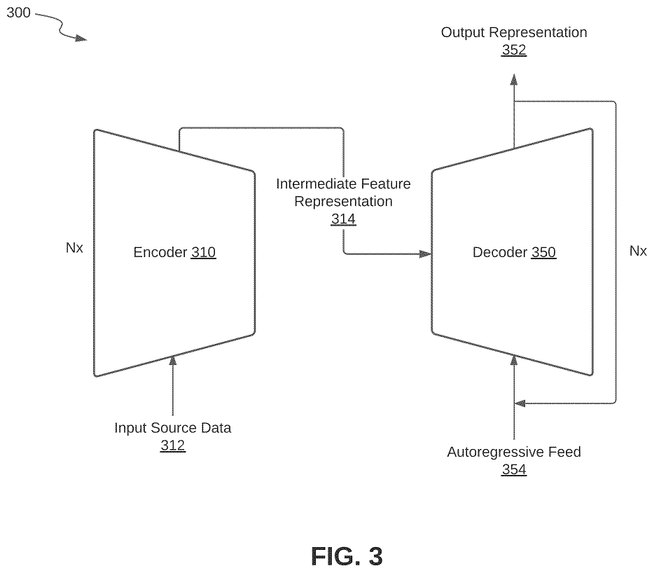

FIG. 3 is a schematic diagram of an example machine learning model 300 for generating representations of three-dimensional features extracted from multiview imagery. The machine learning model 300 is to be understood as one example of a machine learning model that can be applied to generate representations of three-dimensional landcover features, such as a machine learning model of the vector map generator 122 of FIG. 1. However, this is not limiting, and the machine learning model 300 may be applied to generate representations of other kinds of three-dimensional features and objects.

The machine learning model 300 is an autoregressive model comprising an encoder 310 and a decoder 350 which are both deep neural networks. The encoder 310 is trained to process input source data 312, comprising multiview imagery that depicts a three-dimensional feature, to generate an intermediate feature representation 314. The intermediate feature representation 314 encodes key features of the input source data 312, including three-dimensional information about the feature depicted in the multiview imagery. For example, where the machine learning model 300 is applied for the purpose of generating a geometric model of a pitched roof structure of a building, the intermediate feature representation 314 may encode for a representation of geometric information about the roof structure, including the three-dimensional coordinate information of the roof structure, and also the topological and geometric constraints applicable to the roof structure.

In some examples, the intermediate feature representation 314 may encode for not only the three-dimensional information directly, but also aspects of the geometric modeling sequence that prescribes how the geometric model of the three-dimensional feature is to be generated, for example, as described in greater detail below with reference to FIG. 5.

Returning to FIG. 3, the structure of the encoder 310 may include any suitable encoding layers, such as one or more self-attention layers (that apply attention among the elements of the input sequence), one or more convolutional neural network layers (CNN), a combination thereof, or other type of encoding layer capable of encoding key information about the features depicted in the input source data 312. The encoder 310 may comprise a block of several of such encoding layers (Nx) stacked on top of one another.

The decoder 350 is trained to decode the intermediate feature representation 314 into an output representation 352 of the three-dimensional feature. In the example shown, the decoder 350 is autoregressive in that it uses both the intermediate feature representation 314 and any previously-generated elements of the output representation 352, depicted here as the autoregressive feed 354, to generate the output representation 352. As described further below, in some cases the output representation 352 may represent a set of three-dimensional coordinates that form a geometric model. In other cases, the output representation 352 may represent a geometric modeling sequence that prescribes how the geometric model is to be generated, such as the one provided in FIG. 5.

The structure of the decoder 350 may include any suitable decoding layers, such as one or more self-attention layers, one or more cross-attention layers (that applies attention between the elements of the input sequence and the output sequence), one or more deconvolution layers, or a combination thereof. The decoder 350 may comprise a block of several of such decoding layers (Nx) stacked on top of one another.

In terms of architecture of the machine learning model 300, it should be noted that the machine learning model 300 may also include additional components such as embedding layers, positional encoding, additional neural layers, skip connections, output activation functions, and other components, both in addition to or as part of the encoder 310 and decoder 350, and could include repeated blocks of any of the aforementioned layers stacked on top of one another.

Furthermore, it should be understood that the machine learning model 300, including the trained learned neural network weights, biases, activation functions, and other architectural components and functionality may be embodied on a non-transitory machine-readable storage medium in machine-readable programming instructions, and executable by one or more processors of one or more computing devices, which include memory to store programming instructions that embody the functionality described herein and one or more processor to execute the programming instructions.

FIG. 4 is a schematic diagram of an example system 400 for generating geometric models of three-dimensional features extracted from multiview imagery. The system 400 comprises an image encoder 410 that is trained to process input multiview imagery 412 to generate image feature maps 414. In other words, the image encoder 410 may encode each image of the multiview imagery 412 into a respective image feature map. The structure of the image encoder 410 may include any suitable encoding layer network, including one or more convolutional neural network layers (CNNs), one or more visual transformer layers, one or more other neural layers, or a combination thereof, suitable to encode the pixel information (i.e., 3-band, 4-band) of the multiview imagery into image feature maps 414.

The system 400 also comprises a camera parameter embedding layer 416 to encode camera parameter data of the multiview imagery 412. In other words, the camera parameter embedding layer 416 may encode the camera parameter information of each image of the multiview imagery 412 into a respective set of encoded camera parameter data 418. These camera parameters can include any of the internal or external camera parameters that are relevant to capturing three-dimensional position or orientation information (e.g., focal length, lens distortion, camera pose) or derivative representations of such camera parameters (e.g., a 4×4 perspective projection matrix). The structure of the camera parameter embedding layer 416 may include any suitable arrangement embedding layers and/or other neural layers suitable to encode the camera parameter information into encoded camera parameter data 418.

The image feature maps 414 are then combined with the encoded camera parameter data 418 to produce a set of camera parameter-enhanced feature maps 420. The two sets of data may be combined in any suitable way, such as by concatenation, provided that each respective image feature map 414 is associated with the corresponding set of encoded camera parameter data 418. Since the camera parameters contain three-dimensional positional information, the decoder may learn how to leverage this information, in addition to the pixel information, to generate the geometric model, and/or the geometric modeling sequence to generate the geometric model, in three-dimensional space. In comparison to the machine learning model 300 of FIG. 3, the combination of the image encoder 410 and the camera parameter embedding layer 416 may be understood to be similar to the encoder 310 of FIG. 3, and the resulting collection of camera parameter-enhanced feature maps 420 may be understood to be an example of the intermediate feature representation 314.

The system 400 also comprises a decoder 450 that is trained to decode the camera parameter-enhanced feature maps 420 into a tokenized representation 452. In comparison to the machine learning model 300 of FIG. 3, the decoder 450 may be understood to be similar to the decoder 350, and the tokenized representation 452 may be understood to be an example of the output representation 352. Similarly, in the example shown, the decoder 450 is autoregressive in that it uses both the camera parameter-enhanced feature maps 420 and the previously-generated elements of the output tokenized representation 452, depicted here as the autoregressive feed 462, to generate further elements of the output tokenized representation 452.

In some cases, the tokenized representation 452 may represent the set of three-dimensional coordinates that form a geometric model 472 of the three-dimensional feature. In other cases, the tokenized representation 452 may represent a geometric modeling sequence 453, as shown, that prescribes how the geometric model 472 is to be generated. Where the tokenized representation 452 represents a geometric modeling sequence, the tokenized representation 452 may comprise a combination of different types of coordinate tokens that represent positional, topological, and/or geometric features of the geometric model 472.

For example, in some cases, the tokenized representation 452 includes at least three types of tokens, including coordinate tokens, which specify the (X, Y, Z) coordinates of particular elements of the structure being modeled, mesh topology tokens, which may specify the topology of the elements of the structure being modeled (e.g., indicating the start and end vertices of particular mesh structures), and geometric property tokens, which may specify geometric constraints among particular elements of the structure being modeled (e.g., coincidence, parallelism) or other geometric properties. In some cases, the tokenized representation 452 also includes geometric operation tokens, which specify particular geometric modeling operations that are to be taken to form the resulting geometric model (e.g., extrusion). A more detailed explanation of an example geometric modeling sequence that contains some of these token types is provided further below, with regard to FIG. 5.

Returning to FIG. 4, the structure of the decoder 450 may include any suitable decoding layers. In the example shown, the decoder 450 follows a transformer decoder architecture, including a self-attention layer 454 (to apply attention among the elements of the autoregressive feed 462), a cross-attention layer 456 (to apply attention between the elements of the autoregressive feed 462 and the camera parameter-enhanced feature maps 420), and a feed-forward layer 458 for further processing. However, it should be understood that in other examples, other sequential modeling architectures may be used, such as recurrent neural network (RNN) or long short-term memory (LSTM).

In terms of architecture of the image encoder 410, camera parameter embedding layer 416, and decoder 450, it should be understood that these components may include additional components such as embedding layers, positional encoding, additional neural layers, skip connections, output activation functions, and other components, and could include repeated blocks of any of the aforementioned layers stacked on top of one another. In some examples, these various components may be rearranged where appropriate. The attentive layers may apply attention in accordance with any known techniques, including full/global attention, local attention, efficient attention using clustering, and other techniques, and the convolutional layers may be applied in accordance with any known techniques, including the use of several convolutional layers of varying kernel size, and the like.

In some cases, the decoder 450 may be configured to generate geometric property tokens that are designed to be interpreted to impose particular geometric constraints on the geometric model 472 that reflect heuristic constraints suitable to the type of three-dimensional feature being extracted. For example, in the case of a building structure, the decoder 450 may be configured to generate geometric property tokens that indicate that the walls on opposite sides of a building (or opposite edges of a roof outline) are to be interpreted as being parallel to one another, or that adjacent walls around the building (or adjacent edges in a roof outline) are to be interpreted as being perpendicular to one. Some of these geometric constraints may reflect common building practices or even building code regulations. For example, the decoder 450 may be configured to generate geometric property tokens that indicate that the pitch of a roof facet is to conform to a common roof pitch, such as 3/12, 4/12, or 5/12. Again, a more detailed explanation of an example geometric modeling sequence that contains some of these token types is provided further below, with regard to FIG. 5.

As mentioned previously, the tokenized representation 452, like the output representation 352 of FIG. 3, may be converted into a three-dimensional vector map that represents the geometric model 472. In the present example, this functionality takes place at the geometric interpreter 470. The geometric interpreter 470 is configured with a set of rules that provides a complete set of instructions for how to interpret the tokenized representation 452 produced by the decoder 450. In other words, the geometric interpreter 470 is configured to convert, translate, decode, or otherwise interpret the tokenized representation 452 as a set of points, lines, and/or polygons and/or mesh that represents the three-dimensional feature being extracted from the multiview imagery 412. This functionality may include ensuring that a valid selection of tokens from the tokenized representation 452 is used to generate the geometric model 472 (in cases where the elements of the tokenized representation 452 are output as a probabilistic distribution), and may further include functionality to ensure that the geometric constraints that are defined in the tokenized representation 452, are defined above, are satisfied. A more detailed example implementation of the geometric interpreter 470 is provided further below with reference to FIG. 8.

Returning to FIG. 4, the functionality of the system 400 (and any of its subcomponents), including the trained learned neural network weights, biases, activation functions, and other architectural components and functionality, may be embodied in programming instructions and executable by one or more processors of one or more computing devices, which include memory to store programming instructions that embody the functionality described herein and one or more processors to execute the programming instructions.

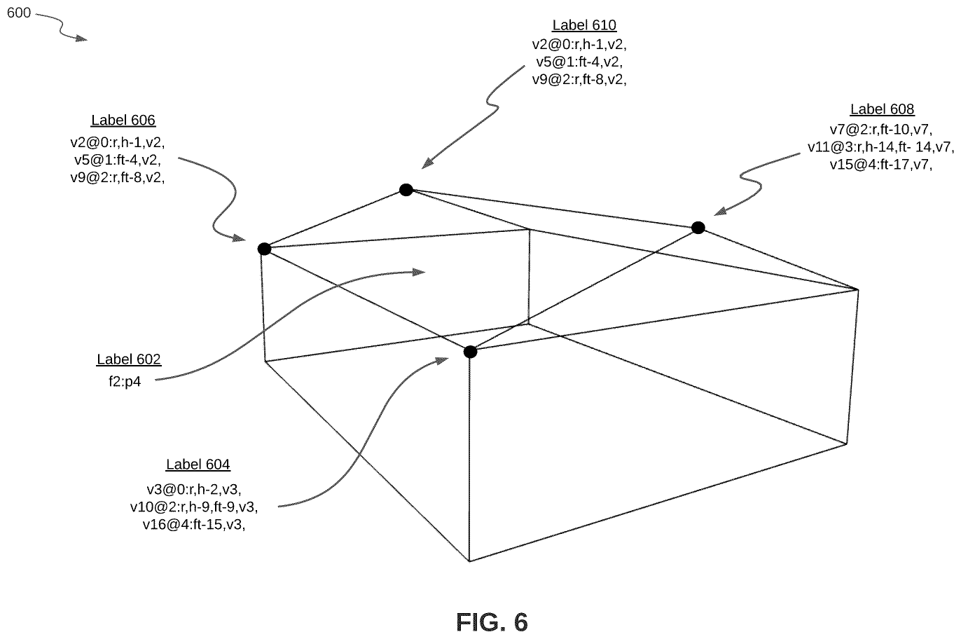

FIG. 5 is an illustration of an example geometric modeling sequence 500 that prescribes how a geometric model of a three-dimensional feature is to be generated (e.g., extracted by the system 400 of FIG. 4, or similar). In the present example, the sequence 500 prescribes how the geometric model 600 of the pitched roof structure depicted in FIG. 6 is to be generated.

The sequence 500 includes a combination of vertex tokens, which specify the coordinates of the vertices of the geometric model 600 (e.g., “V” and “(0.60, −0.17, −0.09)”), mesh topology tokens, which specify the topology of elements of the geometric model 600 (e.g., “START_SURFACE”, “END_CONT”, “END_SURFACE”, “END_MESH”), and geometric property tokens, which specify geometric constraints and other properties of the elements of the geometric model 600, including, in this case, vertices and surfaces (e.g., “VP(r, h, ft, sv)” and “SP(ft, h)”). The sequence 500 also includes a geometric operation token, which specifies a geometric modeling operation to be performed with respect to a geometric entity of the geometric model 600 (e.g., “EXTRUDE”).

For clarity, the elements of the sequence 500 are described metonymically as “tokens”, but it should be understood that, in some cases, an element of the sequence 500 may in fact comprise multiple “tokens” output by a machine learning model (e.g., the vertex token “(0.60, −0.17, −0.09)” may in fact be output as three separate tokens, one for each of the X, Y, and Z coordinates), and conversely, in some cases, multiple elements of the sequence 500 may in fact comprise a single “token” output by the machine learning model (e.g., a surface property token “SP(ft, h)”, which defines two geometric constraints, namely that the surface is both a “building footprint” surface and that each of its vertices should be horizontal to one another, may in fact be captured in a single “token” output by the machine learning model).

For illustrative purposes, the sequence 500 is divided into segments 502, 504, 506, 508, 510, which in this case each prescribe how a different part (i.e., surface) of the geometric model 600 is to be generated. For greater understanding, a representative description of segment 502 is provided below.

Segment 502 begins with a “START_SURFACE” token to indicate the beginning of a new surface of the geometric model 600, followed by a “V” token to indicate the generation of a new vertex, followed by the coordinates “(0.60, −0.17, −0.09)”, to indicate the three-dimensional coordinates of this vertex. These coordinates are followed by a “VP” token, which would normally specify one or more properties applicable to the previously generated vertex (including e.g., geometric constraints). However, since the previously-generated vertex is the first vertex generated for this surface, the vertex properties are withheld at this time, to be filled in later when the surface is closed (when geometric constraints can be expressed with respect to at least one other vertex). This token is followed by another vertex “V” token, and its coordinates (−0.02, 0.62, −0.09), and another vertex property “VP” token. In this case, the “VP” token defines properties “(r, h, ft, sv)”, which indicate that this vertex is at a right angle to the previous vertex and the next vertex (“r”), that this vertex is situated horizontally with respect to the previous vertex (“h”), that this vertex forms part of a “building footprint” line, which means that this vertex makes up a line whose projection in the XY plane is parallel or perpendicular to one of the principal axis of the roof outline (“ft”), and that this vertex is intended to “snap to” the closest nearby vertex (as to be determined by a geometric solver downstream in the process) (“sv”).

As an aside, it should be noted that in some cases, buildings are modeled with two principal directions that are perpendicular to one another (i. e, principal axis), in recognition that it is common for buildings to be built in such a manner that all or most of its exterior walls are parallel or perpendicular to one another. However, it should be understood that this restriction does not necessarily apply in all cases, such as in the case where a building has a more complicated footprint including lines that are not parallel or perpendicular to one another, or when the building footprint includes curved walls, and the like. In such cases, the machine learning model may be configured to avoid generating an (“ft”) token, to indicate to the downstream geometric solver that the generated vertex is on a line that may not necessarily follow one of the aforementioned constraints. Furthermore, it should also be understood that, in a three-dimensional space, a “building footprint” line as described above need not necessarily be directly parallel or perpendicular to one of the two principal axis of the buildings, but rather, what is important is that the projection of the line in the XY plane is parallel or perpendicular to one of these principal axis.

Segment 502 continues with additional vertex tokens and geometric property tokens until an “END_CONT” token is generated, which indicates that the end of a contour, followed by the coordinates of the last vertex of the contour, (0.60, −0.17, −0.09), which notably are coincident with the coordinates of the first vertex. This is followed by a final vertex property token “VOP”, which specifies the properties applicable to the final vertex, which can also be taken to apply to the first vertex, which were omitted earlier.

The end of the contour is followed by an “EXTRUDE” token, which specifies that a geometric extrusion operation is to be performed, and the vector “(0.00, 0.00, −0.27)”, which specifies the directionality and magnitude of the geometric operation of extrusion. In this case, the previously generated contour, which outlines the perimeter of the roof of the building, is extruded downward in the Z direction (i.e., toward the ground). As a result, a downstream geometric solver will be able to interpret that there should be a building footprint polygon beneath the roof outline polygon spaced apart by a distance of 0.27 units (the polygons formed between the roof outline polygon and the building footprint polygon representing the exterior walls of the building). Thus, the sequence 500 represents the building footprint and exterior walls “virtually” without needing to generate the constituent vertices of these geometric elements separately.

Following the extrusion operation, an “END_SURFACE” token indicates that the surface is complete. This is followed by a surface property token “SP(ft, h)”, which indicates that the surface represents the roof outline of the building (“ft”), and that all of the vertices in the surface are horizontal with one another (“h”). This token completes segment 502.

The sequence 500 continues with additional “START_SURFACE” tokens that begin the next surface, and so on, until each of the remaining segments 504, 506, 508, 510, are completely defined. In the illustrated example, whereas the segment 502 represents the roof outline (and “virtual” building footprint and exterior walls”) of the building, the segments 504, 506, 508, and 510 represent the individual roof facets of the building (see FIG. 6).

As another aside, it is also worth noting at this stage that the pitch, or angle of inclination, of the various roof facets can be expressly defined as geometric properties (e.g., segment 504 ends with the surface property token “SP(v)” which indicates that the roof facet is vertical, segment 506 ends with the surface property token “SP(p4)” which indicates that the roof facet has pitch 4/12, which is a common pitch for roof facets (roof pitch is commonly 3/12, 4/12, or 5/12)). If the coordinates of the vertices that make up the roof facet do not necessarily result in the indicated pitch, then the downstream geometric solver may adjust the vertices accordingly until the indicated pitch is satisfied.

The sequence 500 ends with an “END_MESH” token that indicates that the entire mesh for the building is complete. If the sequence 500 were to model additional buildings, the sequence could continue further with a new mesh for each new building.

It should be understood that the sequence 500 is representative only, and that the same geometric model 600 could be represented by a different geometric modeling sequence in which the vertices and surfaces of the geometric model 600 were generated in a different order. In some cases, the sequence 500 could make greater use of mesh topology tokens that prescribe more complicated mesh topology (e.g., a surface could contain more than one contours within it, for example, a cutout for a window). Further, the nomenclature used to indicate the various tokens (e.g., “START_SURFACE”) are representative only, and can be expressed in different ways (e.g., “s_begin”). As another example, indications of pitch may be expressed differently (e. g, “h” may be represented as “p0” to indicate a pitch of zero).

It should also be noted that some of the elements of the sequence 500 may be intended for processing by a downstream geometric solver, which may alter the shape of the geometric model 600 in a meaningful way. For example, the token “VP(r, h, ft, sv)” specifies that the vertex is to “snap to” the nearest vertex—a determination that will be made by a geometric solver, which may ultimately result in the coordinates of the vertex being shifted to precisely equal those of another vertex. As another example, the token “SP(ft, h)” specifies that all of the vertices of the surface make up lines that are parallel or perpendicular to one another in the XY plane (as “building footprint” lines), and that all of the vertices of the surface should be horizontal with one another. As yet another example, “SP(p4)” specifies that the vertices of the surface are to conform to a pitch of 4/12. All of these geometric constraints may require more fine-tuning and adjustments to be made by the geometric solver.

As shown in FIG. 6, the geometric model 600 represents a building with a pitched roof structure. The geometric model 600 may be understood to be similar to the geometric model 472 of FIG. 4, that is, as an example of the output of the geometric interpreter 470 having processed the tokenized representation 452 to convert, translate, decode, or otherwise interpret the tokenized representation 452 as a set of points, lines, and/or polygons and/or mesh that represents a three-dimensional feature extracted from multiview imagery 412.

Furthermore, in the present example, the geometric model 600 is attributed with the same geometric and topological constraints as the geometric modeling sequence 500 of FIG. 5 (which may have been corrected by a geometric interpreter, as described above), although these constraints have been reformatted for attribution to the geometric model 600. As a representative example, the labels on the surface “f2”, and its four constituent vertices, are described below.

Label 602 indicates a surface (named surface “f2”) and indicates that the pitch of the surface is 4/12 (i.e., “p4”). The surface “f2” is formed by four vertices which described further by labels 604, 606, 608, and 610. Before describing the individual labels, it should be understood that, because of the way the machine learning model generated the geometric modeling sequence 500 (i.e., point-by-point and facet-by-facet), each of these four vertices are referenced multiple times, in the generation of each individual roof facet that each vertex forms a part of.

Thus, the label 604 indicates that vertex “3”, which is situated on plane “0” (“3” referring to the third vertex generated in the geometric modeling sequence 500 as plane “0” was being generated), forms a right angle with the adjacent vertices in the sequence in which it was generated (“r”), is horizontal with vertex “2” (see label 606) (“h”), and is merged with vertex “3” (“v3”). Label 604 also indicates that vertex “10”, which is situated on plane “2” (“10” referring to the tenth vertex generated in the geometric modelling sequence 500 as plane “2” was being generated), forms a right angle with the adjacent vertices in the sequence in which it was generated (“r”), is horizontal with vertex “9” (see label 606) (“h”), forms a “building footprint” line with vertex “9” (see label 606) (“ft-9”), and is merged with vertex “3” (i.e., becomes coincident with, or “snaps to” vertex “3”) (“v3”). Label 604 also indicates that vertex “16”, which is situated on plane “4” (“16” referring to the sixteenth vertex generated in the geometric modeling sequence 500 as plane “4” was being generated), forms a “building footprint” line with vertex “15” (see label 608) (“ft-15”), and is merged with vertex “3” (“v3”). Note that each of the three “vertices” described under label 604 are merged together into “v3” (are coincident with one another), but are each described with respect to the geometric and topological constraints that are relevant to the segment of the geometric sequence in which they were generated.

The labels 606, 608, and 610 similarly describe the topological and geometric constraints of the remaining three vertices that form surface “f2”.

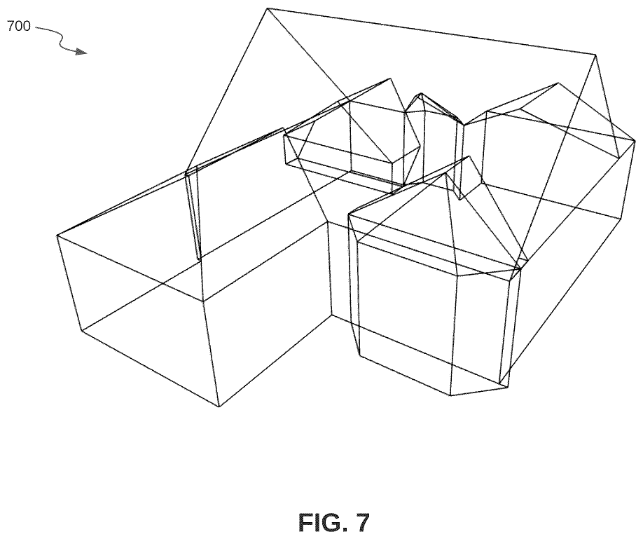

It should be understood that a simple pitched roof structure was chosen for the building that is modeled by the geometric model 600 of FIG. 6 for illustrative purposes. However, it should be understood that the techniques herein may also be used to model more complicated structures, such as the structure shown in FIG. 7.

FIG. 7 illustrates a geometric model 700 of a building with a more complex building footprint that includes external walls that are not parallel or perpendicular to either of the two principal directions of the building (i.e., which are not “building footprint” lines). The geometric model 700 also includes a more complex pitched roof structure, including ridge lines, hips, valleys, and similarly, roof segments that are not parallel or perpendicular to either of the two principal directions of the walls of the building.

FIG. 8 is a schematic diagram of an example geometric interpreter 800. The geometric interpreter 800 may be understood to be one example of the geometric interpreter 470 of FIG. 4, shown in greater detail.

As described above with reference to FIG. 4, one function of the geometric interpreter 470 is to ensure that a valid selection of tokens from the tokenized representation 452 is used to generate the geometric model 472. This step is necessary in cases where the tokenized representation 452 is output as a distribution of possible outputs, referred to here as probabilistic distribution 802. Thus, in FIG. 8, the geometric interpreter 800 includes a probabilistic sampler 810 to sample a sequence of tokens based on the probabilistic distribution 802 of tokens and determine whether the sample sequence of tokens is valid.

At the probabilistic sampler 810, the sequence of token can be determined to be valid or not based on whether the sampled sequence results in valid geometric topology. In other words, the probabilistic sampler 810 determines whether the sampled sequence of tokens contains a valid ordering of mesh topology tokens (e.g., “START_SURFACE”) that results in a valid geometric topology. For example, if the sampled sequence contains one “START_SURFACE” token followed by another “START_SURFACE” token without closing the first surface with an “END_SURFACE” token, then the sampled sequence is invalid. In contrast, the sequence 500 of FIG. 5 is an example of a valid sequence of output tokens. The probabilistic sampler 810 continues to iterate by re-sampling new sequences until a topologically valid sequence 804 is output.

Another function of the geometric interpreter 470 is to ensure that a set of geometric constraints is imposed on the geometric model 472. Thus, in FIG. 8, the geometric interpreter 800 includes a geometric solver 820 that attempts to generate a geometric model based on the sampled sequence in a way that satisfies a set of geometric constraints. In some cases, the geometric constraints may be found in the geometric property tokens of the topologically valid sequence 804 (e.g., “VP(r, h, ft, sv)” and “SP(ft, h)”). In other words, the geometric solver 820 may enforce the geometric constraints encoded into the geometric sequence, such as by adjusting the height of the points that are required to be horizontal with one another, adjusting the relative position of the points that are required to form lines that are parallel or perpendicular to one another (or to form an inclined plane of a particular pitch), and snapping-together vertices that are required to be coincident with one another. In other cases, the geometric constraints may be stored into the geometric solver 820 directly. For example, the geometric solver 820 may apply a heuristic that requires that all points that are within a threshold distance from one another are to be “snapped-to” one another and made coincident, or that the points that form an inclined plane that nearly conforms to a standard pitch (e.g., 3/12, 4/12, 5/12) should be adjusted until the standard pitch is achieved.

In some cases, the geometric solver 820 may be unable to generate the geometric model in a way that satisfies the geometric constraints. For example, the geometric solver 820 may be unable to snap-together two vertices while still maintaining a right angle between one of these vertices and two other vertices. In such a case, the geometric interpreter 800 would then generate a new topologically valid sequence 804 (through the probabilistic sampler 810) and then again attempt to resolve the geometric sequence to satisfy the set of geometric constraints. The geometric solver 820 would continue to iterate until a geometrically (and topologically) valid geometric model 806 is output.

In addition to the functionality described herein, the geometric interpreter 800 may include any additional functionality as would be understood to be required to convert a geometric sequence, such as the geometric sequence 500 of FIG. 5, into a geometric model, such as the geometric model 600 of FIG. 6.

Further, the geometric interpreter 800 may include additional functionality as would be understood to be required to convert a geometric model, such as the geometric model 600 of FIG. 6, into a set of three-dimensional vector data, such as the three-dimensional vector maps 124 of FIG. 1. For example, converting a geometric model into three-dimensional vector data may involve reformatting the data into a form in which superfluous information, such as the particulars of the topological constraints and/or geometric constraints that are imposed on the geometric model, which may be incompatible with, or unnecessary for, a downstream user application, are removed, leaving behind only the three-dimensional coordinate information of the geometric model. The process may also include triangulation, i.e., splitting a polygon into multiple triangles, to be used by downstream graphic rendering systems.

The functionality of the geometric interpreter 800, including the probabilistic sampler 810 and geometric solver 820, and any other functionality described above, may be embodied in programming instructions and executable by one or more processors of one or more computing devices, which include memory to store programming instructions that embody the functionality described herein and one or more processors to execute the programming instructions.

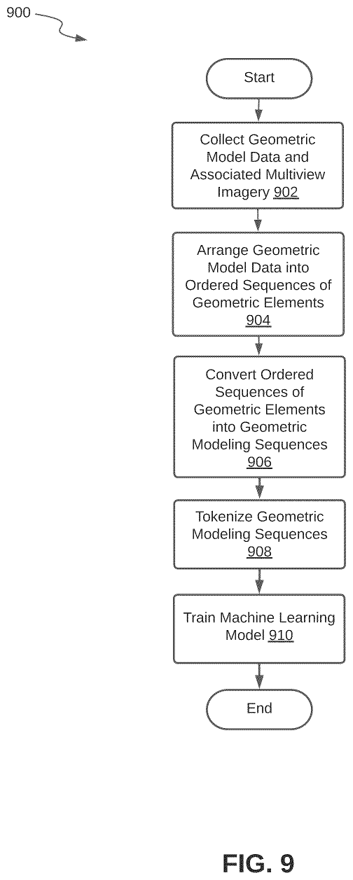

FIG. 9 is a flowchart of an example method 900 for preparing training data to train a machine learning model to generate representations of geometric modeling sequences. The method 900 could be understood as one example of how training data could be prepared to train the machine learning model of the three-dimensional vector map generator 122 of FIG. 1, or the machine learning model 300 of FIG. 3, or the combination of the image encoder 410, camera parameter embedding layer 416, and decoder 450 of FIG. 4, in the particular case where the machine learning model is to be trained to generate representations of geometric modeling sequences.

The method 900 involves, at operation 902, collecting a set of geometric model data and the associated multiview imagery with which the geometric model data was generated. This set of geometric model data may have been generated by one or more users with reference to one or more sets of multiview imagery through any suitable geometric modeling tool that allows users to manually generate geometric models of three-dimensional features with reference to multiview imagery. The set of geometric models should be particular to the type of three-dimensional feature that the machine learning model is to be trained to extract. For example, where the machine learning model is to be trained to generate representations of pitched roof structures, then the geometric model data should comprise a set of geometric models of three-dimensional pitched roof structures. This initial set of geometric model data (and corresponding multiview imagery) may be augmented through any suitable data augmentation techniques.

Commonly, the geometric model data will be stored as an unordered set of geometric entities (e.g., polygons). Even if this data is stored as an ordered sequence, the ordering of the sequence may be arbitrary. Commonly, the geometric model data will include topological information that describes how the vertices of the polygons are connected, but the geometric model data may not necessarily store geometric constraints explicitly (i.e., as attributes). For example, although the geometric modeling tool that was used to generate the geometric models may have permitted the user to specify that some of the lines of the geometric model are to be parallel to one another, perpendicular to one another, or that a group of vertices are to be horizontal with one another (same Z coordinate), or that the vertices of an inclined plane are to satisfy a pre-defined pitch (e.g., pitch 3/12, 4/12, 5/12), the geometric models may not contain explicit information (e.g., attributes) about the geometric constraints that were employed. In such cases, the resulting geometric models may exhibit these geometric constraints inherently, at least within a threshold level of precision (e.g., a roof facet that was defined as having pitch 5/12 may only approximately exhibit a pitch of 5/12 depending on the level of precision of the coordinates of the vertices of the roof facet).

In one particular example, the geometric models may be stored as unordered sets of polygons (e.g., each polygon representing a particular roof facet, or the roof outline, of a building), with each contour being associated with an optional extrude operation. This set of geometric model data may therefore contain geometric models that are similar to the geometric model 600 of FIG. 6, which is divided into each of the individual roof segments, and one roof outline polygon, and where the extrude operation is used for the roof outline polygon.

Although the training data may be stored as an unordered set, a machine learning model that is autoregressive in its architecture (like those described herein) is configured to produce outputs in ordered sequences, and therefore requires training data that is formatted as ordered sequences. Thus, in order to accommodate the case where the geometric model data that is used for training purposes originates as an unordered set of data, the method 900 may involve, at operation 904, arranging the geometric model data into order sequences of geometric elements that defines at least a topologically valid way for the geometric models to be generated. In some cases, this arranging may apply only to the higher-order geometric elements (i.e., polygons), whereas in other cases, this arranging may also apply to the lower-order geometric elements (i.e., vertices).

In some cases, the arrangement that is imposed may be arbitrary, as the purpose of the arranging may merely be to format the training data into a format that is suitable for training an autoregressive machine learning model. Thus, for example, the arranging may involve, for each three-dimensional feature being modeled, rearranging the polygons in order of the highest Z-coordinate, followed by the highest Y-coordinate, followed by the highest X-coordinate. Although arbitrary, formatting the training data into an ordered sequence gives the machine learning model a sequence to follow and thus reduces the complexity of the probability space that needs to be modeled.

In other cases, the arrangement that is imposed may be more deliberate, as a way of dictating the particular modeling sequence that the machine learning model should follow. For example, in the context of generating pitched roof geometry, it may be desired to generate the geometry for the outline of the roof first, followed by the geometry for the individual roof facets (e.g., so that the roof outline can serve as a baseline for the roof facets to connect to). In such a case, the ordered sequences of geometric elements may arranged so that the roof outline polygon comes first in each sequence. In practice, if the geometric models in the training data are stored in a way similar to the geometric model 600 of FIG. 6, then one way in which this could be achieved could be to making polygons with extrusion operations first in the sequence.

The method 900 further involves, at operation 906, converting the ordered sequences of geometric elements into geometric modeling sequences, similar to the geometric modeling sequence 500 of FIG. 5. In other words, each ordered sequence of geometric elements is converted into a sequence of “tokens” containing at least vertex “tokens” and topology “tokens”, and where applicable, geometric constraint “tokens” and geometric operation “tokens” similar to the geometric modeling sequences described elsewhere in this disclosure.

In some cases where, as mentioned above, the geometric models in the training data do not explicitly contain geometric constraint information, geometric constraint information can be directly inserted into the geometric modeling sequences at this stage. This geometric constraint information may be inferred based on a geometric relationship between two or more of the vertices of the geometric model. For example, if all of the vertices in a polygon have approximately the same z-coordinate (e.g., within a particular threshold, such as 1 cm, or another value in arbitrary units), then a geometric constraint that the vertices in the polygon are to be horizontal to one another (i.e., “SP(h)” in FIG. 5) can be inserted into the geometric modeling sequence. As another example, if the angle between adjacent vertices is approximately 90-degrees, or approximately conforms to a standard pitch (e.g., 3/12, 4/12, 5/12), then a geometric constraint that the vertices form a specific angle with respect to one another (i.e., “VP(r)” “SP(p4)” in FIG. 5) can be inserted into the geometric modeling sequence. Any of the other geometric constraints described herein, including constraints relating to “building footprint” lines and “snap-to” vertices, can be similarly incorporated into the geometric modeling sequences at this stage.

The method 900 further involves, at operation 908, tokenizing the geometric modeling sequences. This step should be understood to involve vectorizing, embedding, encoding, or otherwise preparing the “tokens” of the geometric modeling sequences into a format suitable for ingestion into a machine learning model.

Finally, at operation 910, the machine learning model is trained based on the tokenized geometric modeling sequences and the corresponding subsets of the associated multiview imagery. That is, the machine learning model is trained, based on a given set of multiview imagery for context, to produce representations of geometric modeling sequences that prescribe how geometric models of the three-dimensional features depicted in the multiview imagery are to be generated, as described herein.

Certain aspects of the method 900 may be carried out as part of one or more functional processes that are embodied on a non-transitory machine-readable storage medium in programming instructions executable by one or more processors in any suitable configuration, including the computing devices of the systems described here, such as the processing systems 120 of FIG. 1, which may host the geometric modeling tools used to generate such training data, and the additional functionality to convert the training data into a format suitable for ingestion into a machine learning model, as described above.

Thus, the systems and methods described herein may be applied to automatically generate three-dimensional vector data representing geometric models of three-dimensional features. The systems and methods described herein may be applied to any sort of imagery captured to model any sort of three-dimensional structure, and may be particularly useful to extract three-dimensional representations of buildings, especially buildings with complex pitched roof geometry, which are particularly challenging to generate manually at scale.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A method for comprising:
accessing multiview imagery that depicts a three-dimensional feature;
applying a machine learning model to the multiview imagery to generate a representation of the three-dimensional feature; and
outputting the representation.

2. The method of claim 1, wherein the representation of the three-dimensional feature represents a geometric modeling sequence that prescribes how a geometric model of the three-dimensional feature is to be generated.

3. The method of claim 2, wherein the representation that represents the geometric modeling sequence comprises a sequence of tokens that includes one or more of the following:
vertex tokens, which specify three-dimensional coordinates of geometric entities of the geometric model;
mesh topology tokens, which specify topologies of geometric entities of the geometric model;
geometric property tokens, which specify geometric properties of geometric entities of the geometric model; and
geometric operation tokens, which specify geometric modeling operations to be performed with respect to geometric entities of the geometric model;
wherein the geometric entities of the geometric model comprise one or more of: vertices, surfaces, and contours of the geometric model.

4. The method of claim 3, wherein the sequence of tokens comprises a geometric property token that specifies a geometric constraint among geometric entities of the geometric model.

5. The method of claim 2, further comprising generating the geometric model of the three-dimensional feature based on the geometric modeling sequence.

6. The method of claim 5, wherein the sequence of tokens comprises a probabilistic distribution, and wherein generating the geometric model of the three-dimensional feature based on the geometric modeling sequence comprises:
sampling a sample sequence of tokens based on the probabilistic distribution;
determining whether the sample sequence of tokens is topologically valid;
if the sampled sequence of tokens is topologically valid, attempting to generate the geometric model based on the sampled sequence in a way that satisfies a set of geometric constraints;
determining whether the geometric model can be generated to satisfy the set of geometric constraints; and
if the geometric model can be generated to satisfy the set of geometric constraints, outputting the geometric model.

7. The method of claim 6, wherein the three-dimensional feature is a building, and the geometric constraint is a heuristic suitable to buildings.

8. The method of claim 7, wherein the building includes a pitched roof structure, and the geometric constraint is a heuristic suitable to pitched roof structures.

9. The method of claim 1, wherein applying the machine learning model to the multiview imagery to generate the representation of the three-dimensional feature comprises:
encoding the multiview imagery into an intermediate feature representation; and
decoding the intermediate feature representation to produce the representation of the three-dimensional feature.

10. The method of claim 9, wherein encoding the multiview imagery into the intermediate feature representation comprises:
encoding image data of each image of the multiview imagery into a respective image feature map;
encoding camera parameter data of each image of the multiview imagery into a respective set of encoded camera parameter data; and
combining each respective image feature map with its corresponding respective set of encoded camera parameter data to produce a set of camera parameter-enhanced feature maps;
wherein the intermediate feature representation comprises the set of camera parameter-enhanced image feature maps.

11. The method of claim 9, wherein decoding the intermediate feature representation to produce the representation of the three-dimensional feature comprises:
decoding the intermediate feature representation through a transformer decoder architecture that autoregressively decodes the representation as a sequence of tokens while applying cross-attention to the set of camera parameter-enhanced image feature maps and self-attention to the sequence of tokens of the representation.

12. The method of claim 5, further comprising generating a three-dimensional vector map that represents of the three-dimensional feature based on the geometric model.

13. The method of claim 12, further comprising:
formatting the three-dimensional vector map into an end user data file for import into an end user application, wherein the end user application is configured to process the end user data file to produce, based on the end user data file, one or more of: (a) a rendering of a three-dimensional rendering of the three-dimensional feature, and (b) a measurement of the three-dimensional feature.

14. The method of claim 13, wherein the end user application comprises an insurance claims adjustment or underwriting application, and wherein the three-dimensional feature comprises a pitched roof.

15. The method of claim 2, further comprising:
collecting geometric model data and associated multiview imagery, wherein the geometric model data comprises a set of geometric models, wherein each geometric model represents a three-dimensional feature, and wherein each geometric model was generated with reference to a corresponding subset of the associated multiview imagery;
arranging the geometric model data into ordered sequences of geometric elements, wherein each ordered sequence of geometric elements is a topologically valid way for a geometric model of the geometric model data to be generated;
converting the ordered sequences of geometric elements into geometric modeling sequences, wherein each geometric modeling sequence specifies, in an ordered sequence, at least three-dimensional positional information and topology of the vertices of a geometric model of the geometric model data;
tokenizing the geometric modeling sequences; and
training the machine learning model based on the tokenized geometric modeling sequences and the corresponding subset of the associated multiview imagery.

16. The method of claim 15, wherein each geometric modeling sequence further specifies, in the ordered sequence, one or more geometric constraints among the vertices of the geometric model.

17. The method of claim 16, further comprising:
inferring, based on a geometric relationship between two or more of the vertices of the geometric model, a presence of a geometric constraint.

18. The method of claim 17, wherein the presence of the geometric constraint is inferred by determining that the geometric relationship between the two or more of the vertices of the geometric model conforms to the geometric constraint within a specified threshold.

19. A system comprising one or more computing devices configured to:
access multiview imagery that depicts a three-dimensional feature;
apply a machine learning model to the multiview imagery to generate a representation of the three-dimensional feature; and
output the representation.

20. A non-transitory machine-readable storage medium comprising instructions that when executed cause one or more processors to:
access multiview imagery that depicts a three-dimensional feature;
apply a machine learning model to the multiview imagery to generate a representation of the three-dimensional feature; and
output the representation.
